(19) United States
(12) Patent Application Publication
(10) Pub. No.: US 2008/0016024 A1
(43) Pub. Date: Jan. 17, 2008

(54) QUESTIONNAIRE APPARATUS, COMPUTER READABLE MEDIUM STORING PROGRAM, AND COMPUTER DATA SIGNAL

(75) Inventors: Yutaka Andoh, Ashigarakami-gun (JP); Kazushi Ozawa, Minato-ku (JP); Koushi Kawamoto, Ashigarakami-gun (JP); Kazuo Shibuta, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 11/753,826

(22) Filed: May 25, 2007

(30) Foreign Application Priority Data
Jul. 14, 2006 (JP) 2006-193943

(51) Int. Cl. G06F 17/30

(52) U.S. Cl. 707/1; 707/E17.001

(57) ABSTRACT

A questionnaire apparatus includes: a question storage unit that holds plural questions; a selection condition reception unit that receives a selection condition for selecting a question; and a question selection unit that selects a next question from among the questions stored in the question storage unit, based on a question, an answer to the question and a selection condition received by the selection condition reception unit.

### CROSS-REFERENCE TO RELATED APPLICATIONS

This application is based on and claims priority under 35 USC 119 from Japanese Patent Application No. 2006-193943 filed Jul. 14, 2006.

### BACKGROUND

1. Technical Field

The present invention relates to a questionnaire apparatus which issues plural questions to a respondent, a computer readable medium storing a program, and a computer data signal.

2. Related Art

Generally, a respondent to a questionnaire may not accurately answer to the questions due to influence of his/her psychological condition and habit. In this case, the answer is different from the respondent's intention. Accordingly, the collected answers may lack accuracy. On the other hand, a questionnaire administrator (inquirer) may want to obtain accurate survey results, and further want to include a question to be infallibly answered in the questionnaire.

### SUMMARY

According to an aspect of the invention, there is provided a questionnaire apparatus including: a question storage unit that holds plural questions; a selection condition reception unit that receives a selection condition for selecting a question; and a question selection unit that selects a next question from the questions stored in the question storage unit, based on a question, an answer to the question and the selection condition received by the selection condition reception unit.

### BRIEF DESCRIPTION OF THE DRAWINGS

An exemplary embodiment of the present invention will be described in detail based on the following figures, wherein:

FIG. 1A is a sample of a screen image displayed by a questionnaire apparatus according to the present invention, as a question screen image in which an answer is inputted;

FIG. 1B is a sample of a screen image displayed by the questionnaire apparatus according to the present invention, as a next question selection screen image for selection of the next question;

FIG. 1C is a sample of a screen image displayed by the questionnaire apparatus according to the present invention, as a next question screen following the question shown in FIG. 1A;

FIG. 2 is a block diagram showing the hardware configuration of a questionnaire apparatus 10 according to an exemplary embodiment of the present invention, with a controller 12 as a main element;

FIG. 3 is a block diagram showing the functional structure of a questionnaire program 4 performed by the controller 12 of the questionnaire apparatus 10 according to the exemplary embodiment of the present invention;

FIG. 4 is a sample of questions stored in a question DB 44;

FIG. 5A is an explanatory view of the structure of a questionnaire survey conducted by the questionnaire apparatus 10;

FIGS. 5B and 5C are samples of selection conditions stored in a selection condition storage part 54; and

FIG. 6 is a flowchart showing questionnaire processing (S10) based on the questionnaire program 4.

### DETAILED DESCRIPTION

First, to assist understanding of the present invention, the outline of the present invention will be described.

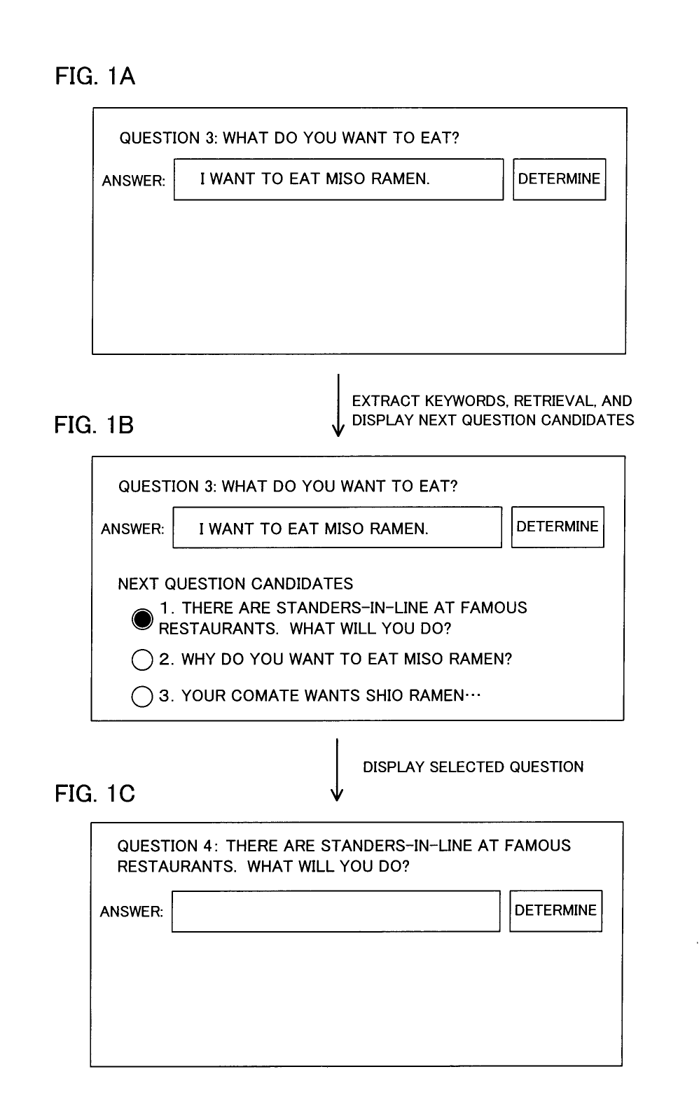

FIGS. 1A, 1B and 1C are samples of screen images displayed by a questionnaire apparatus according to the present invention. FIG. 1A shows a question screen image in which an answer is inputted. FIG. 1B shows a next question selection screen image for selection of the next question. FIG. 1C shows a next question screen image following the question shown in FIG. 1A.

As shown in FIG. 1A, the question screen image includes a question, an answer input field and an enter key. A questionnaire survey is conducted by a respondent's reading a question then inputting an answer into the answer input field, and depressing the enter key. In this manner, the questionnaire apparatus according to the present invention collects answers to a predetermined question.

When the respondent answers the question, then the questionnaire apparatus according to the present invention displays one or more next question candidates (candidate questions) on the screen as shown in FIG. 1B. The questionnaire apparatus extracts keywords from the answered question (What do you want to eat?”) and the answer inputted in response to the question (“I want to eat miso ramen”), then searches a question database (DB) based on the keywords, and displays retrieved questions as the next question candidates. The question DB holds plural previously-registered questions, and plural keywords are previously set in the questions.

For example, as the keywords, the questionnaire apparatus extracts “what you want to eat” from the question, and extracts “miso ramen” and “want to eat” from the answer. The questionnaire apparatus retrieves “There are standers-in-line at famous restaurants. What will you do?”, “Why do you want to eat miso ramen?” and “Your comate wants shio ramen . . . ” from the question DB as questions corresponding to the extracted keywords.

In the next question selection screen image, a selection unit is displayed for selecting one of the plural question candidates. The selection unit is realized with e.g. a radio button. When the respondent selects one question using the radio button, the questionnaire apparatus according to the present invention displays the selected question as the next question as shown in FIG. 1C, and receives an answer to the question. Note that the selection unit may be realized with a pop down menu, or may be realized by direct input of one of numbers allotted to the questions.

Further, selection conditions for selecting questions from the question DB are previously set in the questionnaire apparatus according to the present invention. The selection conditions include a checkpoint question (priority question) and a checkpoint arrival condition. The checkpoint question is prepared by the questionnaire inquirer as a question to be infallibly answered. The checkpoint arrival condition is a condition for issuance of the checkpoint question. When the checkpoint arrival condition is satisfied, the questionnaire apparatus according to the present invention retrieves the checkpoint question from the question DB without retrieval of next question candidates, and displays the retrieved checkpoint question as the next question.

Hereinbelow, a questionnaire apparatus 10 according to an exemplary embodiment of the present invention will be specifically described.

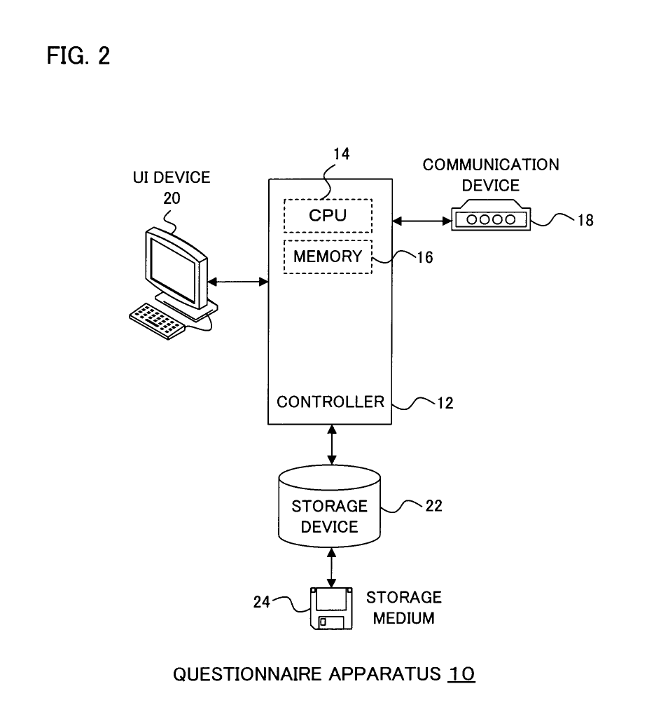

FIG. 2 is a block diagram showing the hardware configuration of the questionnaire apparatus 10 according to the exemplary embodiment of the present invention, with a controller 12 as a main element.

As shown in FIG. 2, the questionnaire apparatus 10 has a controller 12 including a CPU 14, a memory 16 and the like, a communication device 18 which performs data transmission/reception with an external computer or the like via a network, a storage device 22 such as a hard disk drive, and a user interface (UI) device 20 including a display such as a liquid crystal display, a keyboard and a pointing device such as a mouse.

The questionnaire apparatus 10 is, e.g., a general purpose computer in which a questionnaire program 4 to be described later and the like are installed. The questionnaire apparatus 10 holding plural questions receives a condition for selecting a question, and selects a next question from the stored questions based on a question, an answer to the question and the received selection condition. Note that the questionnaire apparatus 10 may obtain answer data to the questionnaire via the keyboard and the mouse of the UI device. Further, the questionnaire apparatus 10 may function as a server, and display the question and obtain the answer data via the communication device 18.

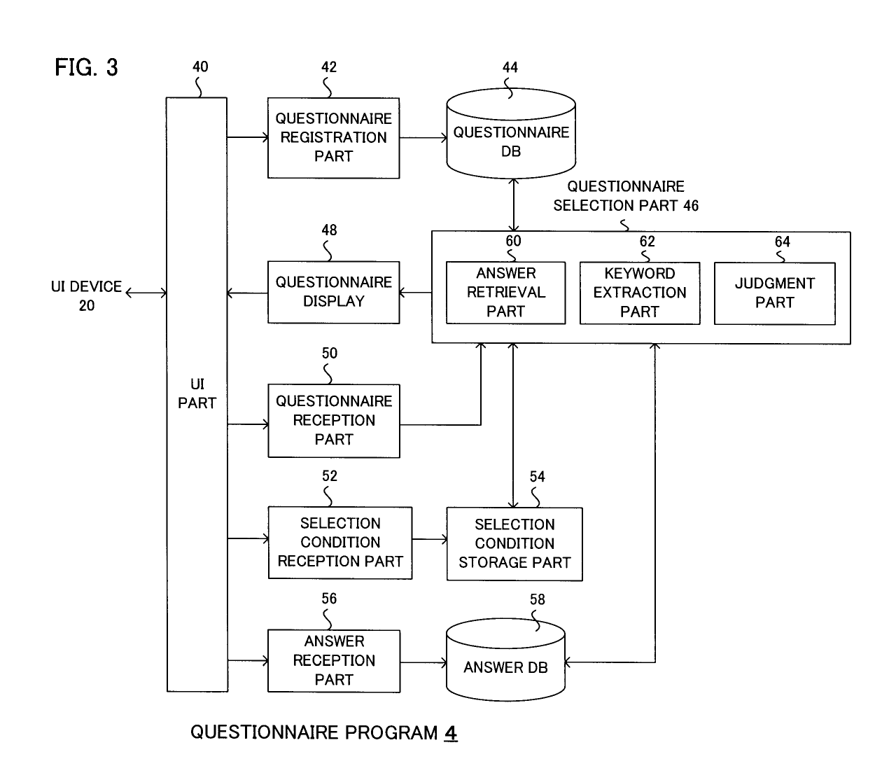

FIG. 3 is a block diagram showing the functional structure of the questionnaire program 4 performed by the controller 12 of the questionnaire apparatus 10 according to the exemplary embodiment of the present invention.

As shown in FIG. 3, the questionnaire program 4 has a user interface (UI) part 40, a question registration part 42, a question DB 44, a questionnaire selection part 46, a question display 48, a question reception part 50, a selection condition reception part 52, a selection condition storage part 54, an answer reception part 56 and an answer DB 58. The question selection part 46 has a question retrieval part 60, a keyword extraction part 62 and a judgment part 64.

The questionnaire program 4 is supplied to the controller 12 from e.g. an external computer connected to a network (not shown) via the communication device 18, loaded into the memory 16, and performed by utilizing the hardware on an OS (not shown) running on the controller 12. Note that the questionnaire program 4 may be stored on a storage medium 24 such as an FD, a CD or a DVD and supplied to the questionnaire apparatus 10.

In the questionnaire program 4, the UI part 40 receives an operation by the respondent or the inquirer with respect to the UI device 20, and outputs it to the respective constitute elements of the questionnaire program 4. Further, the UI part 40 displays information and data generated by the respective constitute elements, contents of processing in the respective constitute elements, and the like, on the display of the UI device 20. Note that when the questionnaire apparatus 10 performs data transmission/reception with the external computer via the communication device 18, the UI part 40 performs communication processing necessary for the communication with the computer.

The question DB 44 is used as a question storage unit that holds plural questions. The question DB 44 is realized with at least one of the memory 16 and the storage device 22. Note that the questions stored in the question DB will be described in detail later.

The question registration part 42 receives a question inputted by the questionnaire inquirer or an administrator of the questionnaire apparatus 10 via the UI device 20, and registers the question into the question DB 44. Further, the question registration part 42 receives instructions of update, deletion and the like of the questions via the UI device 20, and performs update, deletion and the like of the questions stored in the question DB 44. Note that the question registration part 42 may receive instructions of registration, update, deletion and the like of the questions via the communication device 18.

The answer DB 58 holds the respondent's answer to a question. As in the case of the question DB 44, the answer DB 58 is realized with the storage device 22 or the like. The answer reception part 56 receives an answer inputted by the respondent using the UI device 20 via the UI part 40 and stores it in the answer DB 58.

The selection condition reception part 52 receives a condition for selecting a question (selection condition) via the UI device 20, and stores it in the selection condition storage part 54. Note that the selection condition reception part 52 may receive a selection condition via the communication device 18. Further, the selection condition will be described in detail later.

The selection condition storage part 54 holds the selection condition received by the selection condition reception part 52. As in the case of the question DB 44, the selection condition storage part 54 is realized with the storage device 22 or the like.

The question selection part 46 selects question(s) from among the questions stored in the question DB 44 based on a question, an answer to the question and the selection condition received by the selection condition reception part 52, as next question(s). More particularly, when a checkpoint arrival condition to be described later is satisfied, the question selection part 46 selects a checkpoint question as the next question from the question DB 44, otherwise, extracts keywords from the question and the answer to the question and retrieves next question candidates as the next questions based on the keywords.

In the question selection part 46, the judgment part 64 refers to the checkpoint arrival condition stored in the selection condition storage part 54 and judges whether or not the checkpoint arrival condition is satisfied. When the judgment part 64 judges that the checkpoint arrival condition is not satisfied, the keyword extraction part 62 extracts keywords from the question and the answer to the question. The question retrieval part 60 retrieves questions from the question DB 44 based on the keywords extracted by the keyword extraction part 62. Note that question selection processing by the question selection part 46 will be described in detail later.

The question display 48 displays the question(s) selected by the question selection part 46 on the UI device 20. More particularly, the question display 48 displays the candidate questions retrieved by the question retrieval part 60 or the checkpoint question. When the question display 48 displays plural candidate questions as the next question candidates, the question display 48 controls the display order of the next question candidates based on the number of selected times of each question from the candidate questions. For example, the question display 48 displays the next question candidates in descending order of numbers of selected times.

The question reception part 50 receives a question selected by the respondent from the plural candidate questions via the UI device 20, and outputs it to the question selection part 46. In this case, the question selection part 46 retrieves the question received from the question reception part 50 as the next question from the question DB 44, and the question display 48 displays the retrieved question on the UI device 20.

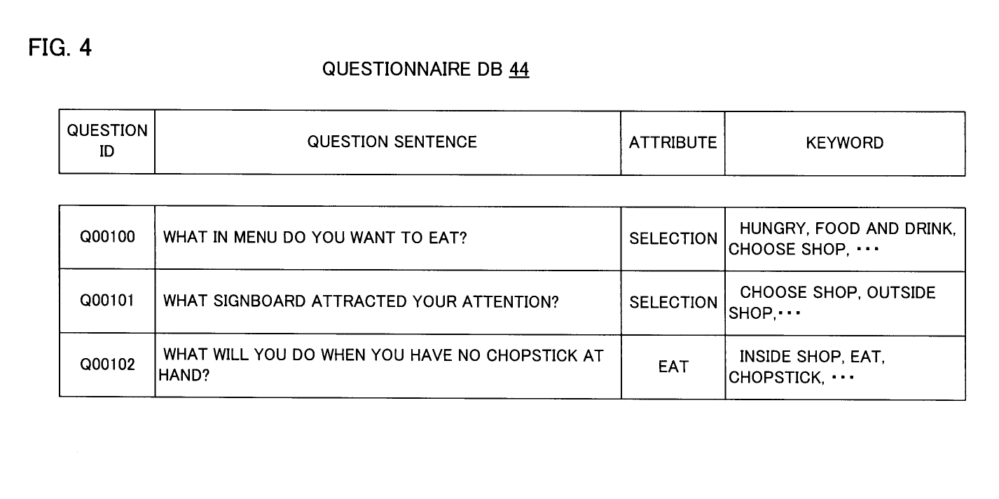

FIG. 4 is a sample of the questions stored in the question DB 44.

As shown in FIG. 4, the respective question data include a question identifier (ID), a question sentence, an attribute and a keyword. The question ID is a character string of e.g. alphanumeric letters to uniquely identify the question. The question sentence indicates the content of the question. In addition to the sentence, image data and/or audio data as a question may be allocated to the question sentence. The attribute which indicates the category classified based on condition of question is, “selection”, “food and drink”, “eat”, “before entrance”, “article selection” or the like. The keyword is one or more continuous words related to the question, and is used as a retrieval key. These questions are registered by the question registration part 42 in the question DB 44, and retrieved and selected by the question selection part 46.

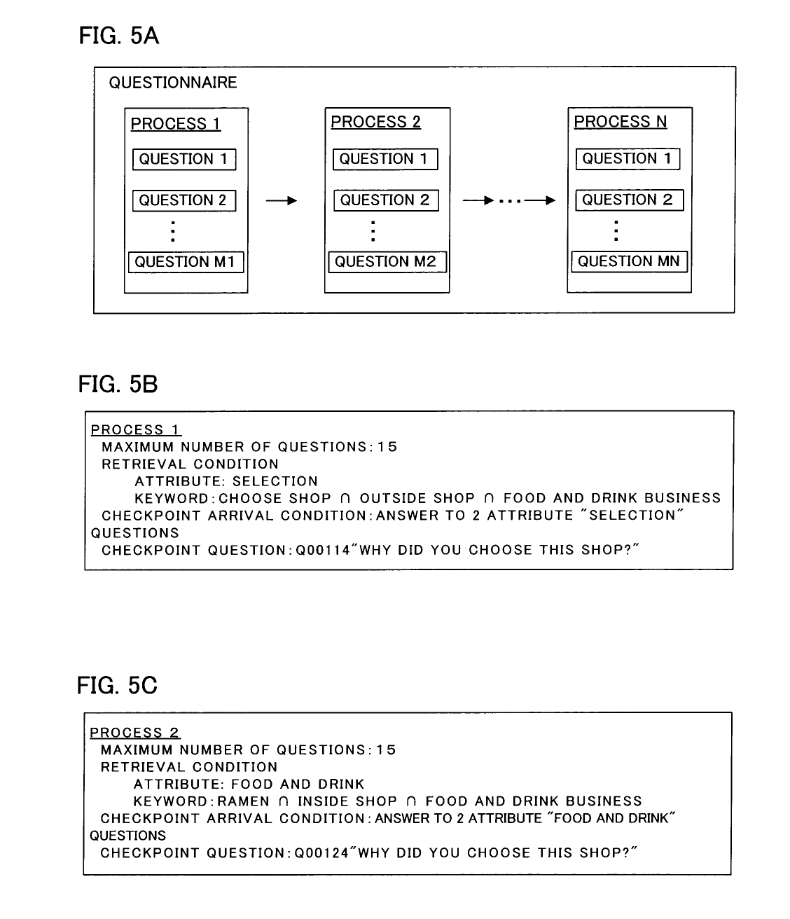

FIGS. 5A, 5B and 5C are explanatory view of the structure of a questionnaire survey conducted by the questionnaire apparatus 10 and the selection conditions stored in the selection condition storage part 54. FIG. 5A shows the structure of the questionnaire survey. FIGS. 5B and 5C are samples of the selection conditions.

As shown in FIG. 5A, the questionnaire survey includes one or more processes, and each process includes plural questions. Each process ends when a predetermined condition is satisfied, and the next process starts. When the final process ends, the questionnaire survey is completed.

The selection condition is set for each process. The questionnaire inquirer inputs a selection condition using the UI device 20 for collection of questionnaire data. The selection condition reception part 52 of the questionnaire program 4 receives, as the selection conditions, a checkpoint question (priority question), a checkpoint arrival condition for selection of the checkpoint question from the question DB 44 (priority question selection condition), and a retrieval condition for retrieval of questions stored in the DB 44 when the checkpoint arrival condition is not satisfied.

As shown in FIGS. 5B and 5C, the selection condition includes a maximum number of questions, a retrieval condition, the checkpoint arrival condition and the checkpoint question. The maximum number of questions is a maximum number of questions in the process. The retrieval condition includes an attribute and a keyword. The attribute in the retrieval condition is used for selection of question in the process. Accordingly, the question retrieval part 60 of the question selection part 46 refers to the attribute as the retrieval condition of the process, and retrieves candidate questions based on the attribute. More particularly, the question retrieval part 60 retrieves questions where the attribute is set from the question DB 44.

Further, the keyword in the retrieval condition is used for selection of question in the process. For example, the keyword is set as “all ‘shop selection’, ‘outside shop’ and ‘food and drink business’ included”. In this case, a question in which all the keywords of the retrieval condition are set is retrieved in the process. More particularly, the question retrieval part 60 refers to the keyword as the retrieval condition of the process, extracts keywords from the question and the answer to the question, and retrieves questions from the question DB 44 based on the keyword as the retrieval condition and the extracted keywords.

For example, the question retrieval part 60 retrieves candidate questions including at least one of the keyword as the retrieval condition of the process and the keywords extracted from the question and the answer to the question. The question retrieval part 60 may retrieve questions including all the retrieval condition of the process and the keywords extracted from the question and the answer.

The checkpoint arrival condition is judged by the judgment part 64 of the question selection part 46. For example, in a case where the checkpoint arrival condition is set as “answer to 2 attribute ‘selection’ questions”, when answers to two questions where the attribute “selection” is set are obtained, the judgment part 64 judges that the checkpoint arrival condition is satisfied. When the judgment part 64 judges that the checkpoint arrival condition is satisfied, the question retrieval part 60 retrieves a question set as the checkpoint question from the question DB 44. In this case, the question selection part 46 selects the checkpoint question as the next question. As shown in FIG. 5B, in the process 1, the question with question ID “Q00114” is the checkpoint question.

The checkpoint arrival condition is also a process completion condition. In this case, the process ends when the checkpoint arrival condition has been satisfied and the checkpoint question has been issued, and moves to the next process. Note that the process completion condition may be satisfaction of the maximum number of questions. In this case, even when the checkpoint question has been issued, the question is retrieved based on the retrieval condition.

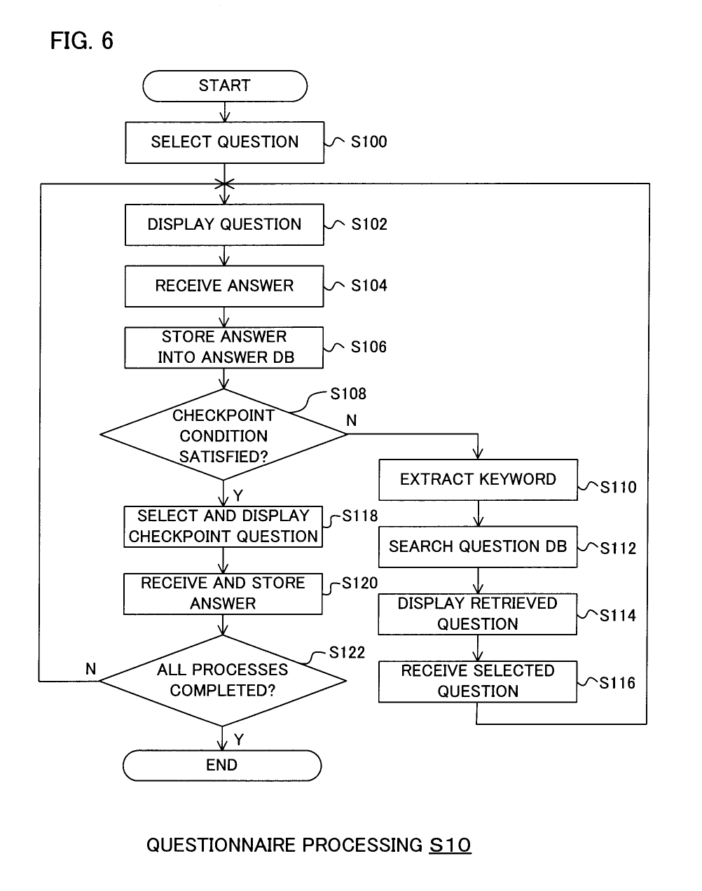

FIG. 6 is a flowchart showing questionnaire processing (S10) based on the questionnaire program 4.

As shown in FIG. 6, at step S100, the question retrieval part 60 of the question selection part 46 refers to a selection condition stored in the selection condition storage part 54, and retrieves and selects a question from the question DB 44 based on a retrieval condition set in the process. The question selection part 46 outputs the retrieved question to the question display 48. Note that the selection condition is previously inputted by the questionnaire inquirer in the questionnaire apparatus 10, received by the selection condition reception part 52 and stored in the selection condition storage part 54.

At step S102, the question display 48 displays a question screen image including the question and the answer input field on the UI device 20.

At step S104, when the respondent inputs an answer, the answer reception part 56 receives the answer inputted via the UI device 20.

At step S106, the answer reception part 56 stores the received answer into the answer DB 58. In this manner, the answer is stored into the answer DB 58.

At step S108, the judgment part 64 of the question selection part 46 refers to a checkpoint arrival condition stored in the selection condition storage part 54, and judges whether or not the checkpoint arrival condition is satisfied. For example, the judgment part 64 judges whether or not two questions having attribute “selection” have been answered. When the judgment part 64 judges that the checkpoint arrival condition is satisfied, the question selection part 46 proceeds to processing at step S118, otherwise, proceeds to processing at step S110.

At step S110, the keyword extraction part 62 of the question selection part 46 refers to the answer DB 58, and extracts keywords from the question and the answer to the question.

At step S112, the question retrieval part 60 retrieves questions from the question DB 44 based on the keywords extracted by the keyword extraction part 62. For example, the question retrieval part 60 retrieves questions which satisfy the retrieval condition (attribute and keyword) stored in the selection condition storage part 54 and in which at least one of the extracted keywords is set as a keyword, from the question DB 44.

At step S114, the question selection part 46 outputs the questions retrieved by the question retrieval part 60 to the question display 48, and the question display 48 displays the retrieved questions as the next question candidates in e.g. descending order of numbers of times selected by the respondent in the past, and displays a selection unit (e.g., radio buttons) to select a next question.

At step S116, when the respondent selects the next question from the next question candidates, the question reception part 50 receives the selected question and outputs it to the question selection part 46. The question selection part 46 outputs the received question as the next question to the question display 48. Thereafter, the questionnaire program 4 returns to the processing at step S102.

On the other hand, when it is judged that the checkpoint arrival condition is satisfied, then at step S118, the question retrieval part 60 of the question selection part 46 retrieves the checkpoint question from the question DB 44. The question selection part 46 outputs the checkpoint question to the question display 48, and the question display 48 displays a question screen image including the checkpoint question and the answer input field on the UI device 20.

At step S120, when the respondent inputs an answer to the checkpoint question, the answer reception part 56 receives the input answer, and stores it into the answer DB 58. In this manner, plural questions are issued in one process.

At step S122, the question selection part 46 judges whether or not all the processes included in the questionnaire have been completed. When all the processes have been completed, the questionnaire program 4 ends, otherwise, the process proceeds to the next process, and the questionnaire program 4 returns to the processing at step S102. In this manner, all the processes included in the questionnaire are performed.

Note that the questionnaire apparatus 10 may be realized as a general purpose computer, or may be realized as a server. When the questionnaire apparatus 10 is realized as a server, a question and an answer to the question are transmitted/received between the questionnaire apparatus 10 and a client used by the respondent via the network. Further, the questionnaire apparatus 10 may be realized as so-called electronic paper (also referred to as “e-Paper”) which includes a controller and on which the questionnaire program 4 operates. In this case, the respondent inputs an answer into the electronic paper, thereby the questionnaire processing based on the questionnaire program 4 is performed.

Further, the questionnaire apparatus 10 may be realized as a question and answer machine for business promotion. In this case, a salesman (respondent) inputs a client's need in a business scene, a business situation, a commercial article or the like as an answer. Further, on the screen, a transaction corresponding to the answer is displayed as a question.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A questionnaire apparatus comprising:
a question storage unit that holds a plurality of questions;
a selection condition reception unit that receives a selection condition for selecting a question; and
a question selection unit that selects a next question from among the questions stored in the question storage unit, based on a question, an answer to the question and the selection condition received by the selection condition reception unit.

2. The questionnaire apparatus according to claim 1, wherein the selection condition reception unit receives, as selection conditions, a priority question, a priority question selection condition for selecting the priority question from the question storage unit, and a retrieval condition for retrieving the questions stored in the question storage unit when the priority question selection condition is not satisfied.

3. The questionnaire apparatus according to claim 2, wherein when the priority question selection condition received by the selection condition reception unit is satisfied, the question selection unit selects the priority question, as a next question, from the questions stored in the question storage unit.

4. The questionnaire apparatus according to claim 2, wherein the question selection unit has a retrieval unit that, when the priority question selection condition received by the selection condition reception unit is not satisfied, retrieves one or more candidate questions from the questions stored in the question storage unit based on the question, an answer to the question and the retrieval condition received by the selection condition reception unit.

5. The questionnaire apparatus according to claim 4,
wherein the question storage unit holds a question with an attribute,
the selection condition reception unit receives the attribute of the question as a retrieval condition, and
the retrieval unit retrieves the candidate questions based on the attribute received by the selection condition reception unit.

6. The questionnaire apparatus according to claim 4,
wherein the question storage unit holds a question with a keyword,
the selection condition reception unit receives the keyword as the retrieval condition, and
the retrieval unit retrieves the candidate questions based on the keyword received by the selection condition reception unit and a keyword included in at least one of the question and the answer to the question.

7. The questionnaire apparatus according to claim 4, further comprising:
a question display that displays the candidate questions retrieved by the retrieval unit; and
a selected question reception unit that receives a question selected from among the candidate questions displayed by the question display,
wherein the question selection unit sets the question received by the selected question reception unit as the next question.

8. The questionnaire apparatus according to claim 7, wherein the question display controls a display order of the candidate questions retrieved by the retrieval unit based on the numbers of selected times of the questions.

9. A computer readable medium storing a program causing a computer to execute a process for a questionnaire apparatus including a computer and a question storage unit that holds a plurality of questions, the process comprising:
receiving a selection condition for selecting a question; and
selecting a next question from among the questions stored in the question storage unit, based on a question, an answer to the question, and the received selection condition.

10. A computer data signal embodied in a carrier wave for enabling a computer to execute a process comprising:
receiving a selection condition for selecting a question; and
selecting a next question from among the questions stored in the question storage unit, based on a question, an answer to the question, and the received selection condition.
